(19) United States
(12) Patent Application Publication
(10) Pub. No.: US 2011/0023358 A1
(43) Pub. Date: Feb. 3, 2011

(54) PLANT GROWING MACHINE

(76) Inventor: Edward J. Marchildon, Qualicum Beach (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/935,561

(22) PCT Filed: Apr. 9, 2009
(86) PCT No.: PCT/CA09/00467

§ 371 Date: Sep. 29, 2010

(30) Foreign Application Priority Data
Apr. 14, 2008 (CA) 2,629,052

(51) Int. Cl. A01G 9/12; A01G 9/02

(52) U.S. Cl. 47/66.6; 47/44

(57) ABSTRACT

An apparatus for growing plants comprises a rotatable plant-holding member having an axis of rotation that is at an angle from the vertical, for example a horizontal axis. Holding means are provided on the plant-holding member for holding plants for growth in a direction parallel to the axis of rotation of the plant-holding member. The apparatus includes support means for supporting the plant-holding member for rotation about its axis of rotation and means for rotating the plant-holding member. The plant-holding member may be a disk, cylinder, or helical blade.

### TECHNICAL FIELD

The invention pertains to apparatuses for growing plants, and in particular to apparatuses in which the plants grow in a non-vertical direction.

### BACKGROUND

Cultivated plants are commonly grown in horizontal beds in which the plant stems grow upwardly. Plant stems placed on their sides tend to bend upwards as they grow, being subject to geotropism. It is believed that this is caused by the movement of plant growth hormones known as auxins to the bottom side of the stem, causing elongation of the cells on the bottom side of the stem. It would be desirable to provide an apparatus by which this property of plants can be utilized to make the plants grow more rapidly to a harvestable size.

### SUMMARY OF THE INVENTION

The invention provides an apparatus for growing plants which has a rotatable plant-holding member having an axis of rotation that is at an angle from the vertical, for example a horizontal axis of rotation, and has a circumferential rim. The apparatus has means on the plant-holding member for holding plants for growth in a direction that is approximately parallel to the axis of rotation of the plant-holding member. The apparatus has support means for supporting the plant-holding member at a non-axial position thereof, for example at its circumferential rim, for rotation about its axis of rotation, and means for rotating the plant-holding member. According to one embodiment, the plant-holding member is a disk. According to another embodiment, the plant-holding member is a cylindrical structure having two outwardly-facing sides from which the plant shoots grow.

The invention further provides an apparatus for growing plants which has a rotatable plant-holding member having an axis of rotation that is at an angle from the vertical, for example a horizontal axis of rotation, the plant-holding member comprising a helical member. There are holding means on the helical member for holding plants. The apparatus has support means for supporting the helical member for rotation about its axis of rotation, and means for rotating the helical member.

The apparatus of the invention can be used for growing a wide variety of cultivated plants, including food plants such as lettuce, spices, etc. either hydroponically, aeroponically or using soil or other media. Any growable plant materials may be employed for growing the plants, for example seedlings, seeds, sprouts, cuttings, clones, etc.

The invention further provides a method of growing plants. An apparatus is provided comprising a rotatable plant-holding member having an axis of rotation that is at an angle from vertical, for example a horizontal axis, the plant-holding member comprising a helical member having a forward side and a rearward side, holding means on the helical member for holding plants, support means for holding the helical member for rotation about its axis of rotation, and means for rotating the helical member. Plant material, for example seedlings, are planted for growth in the plant-holding means on the helical member. The helical member is rotated and water and/or nutrients are delivered to the seedlings.

These and other features of the invention will be apparent from the following description of the drawings of the preferred embodiments.

### BRIEF DESCRIPTION OF THE DRAWINGS

FIG. 1 is a perspective view of a rotary plant-growing apparatus according to one embodiment of the invention.

FIG. 2 is a side elevation view thereof.

FIG. 3 is a back side elevation view thereof.

FIGS. 3A and 3B are detail views of the root holder.

FIG. 3C is a perspective view of an embodiment of the plant holder having a cover on its back side.

FIG. 4 is a perspective view of a rotary plant-growing apparatus according to another embodiment of the invention.

FIG. 5 is a side elevation view of the embodiment of FIG. 4.

FIG. 6 is a perspective view of a rotary plant-growing apparatus according to a further embodiment of the invention.

FIG. 7 is a front elevation view of the embodiment of FIG. 6.

FIG. 8 is a side view of a further embodiment of the invention.

### DESCRIPTION OF THE PREFERRED EMBODIMENTS

In the following description and the drawings, corresponding and like parts are referred to by the same reference characters.

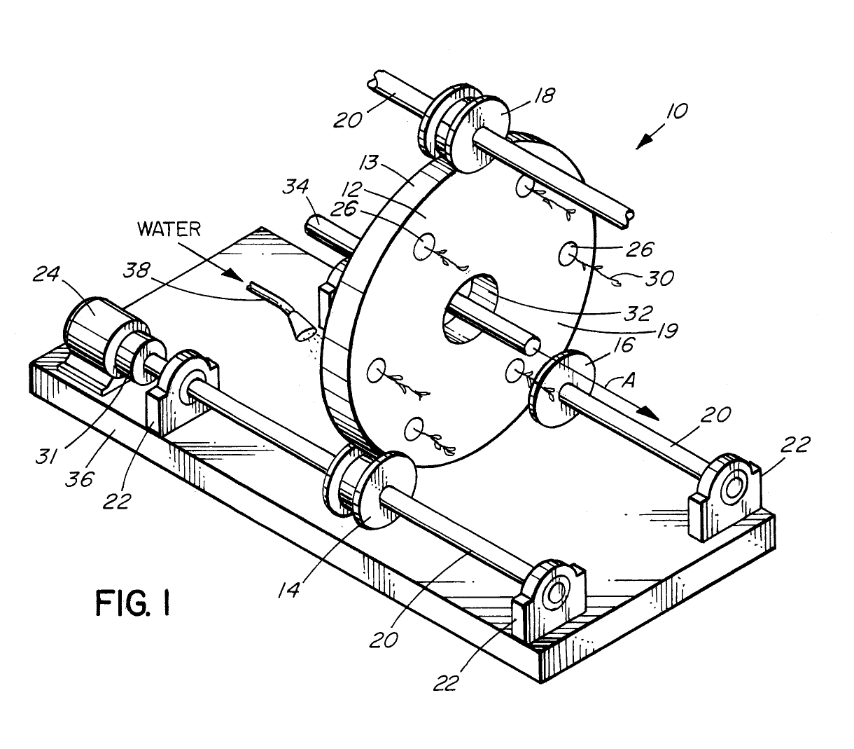

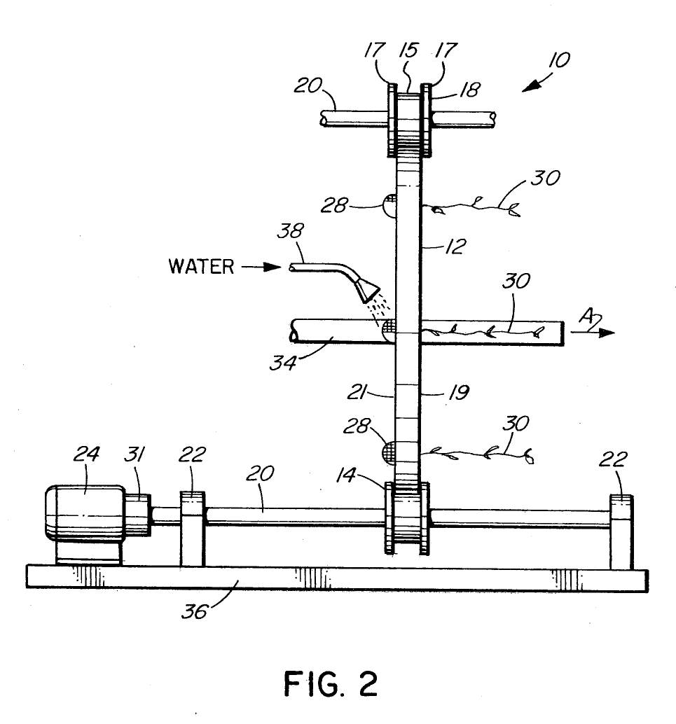

Referring to FIGS. 1 to 3, the plant-growing apparatus 10 has a rotatable plant-holding member in the form of a disk 12 which is held for rotation about its axis of rotation, indicated by arrow A, by two lower support wheels 14, 16 and an upper support wheel 18. The disk 12 has a circumferential rim 13 which fits into a groove 15 between two flanges 17 of the support wheels 14, 16, 18, thus holding the disk for rotation about an axis which is approximately horizontal.

The lower support wheels 14, 16 have axles 20 which are rotatable on support bearings 22, which support the axles on a table 36 or other support surface. The upper support wheel 18 also has axles 20 and is supported by bearings on a support frame (not shown in the drawings) to permit the wheel 18 to rotate. One of the lower support wheels 14 is connected by its axle 20 and a gearbox 31 to an electric motor 24, for rotating the support wheel 14 and accordingly the disk 12.

The disk 12 has a front side 19 and a back side 21. It has a plurality of receptacles 26 in which plants 30 are grown. A root holder 28 is affixed behind each receptacle 26 at the back side 21 of the disk to hold the roots of the plant 30 which grows through the receptacle. The root holder is water-permeable, at least in part, to permit the watering of plant roots by the application of water from a water sprayer 38 onto the root holders 28. The root holder houses a conventional hydroponic medium to support the plant roots and retain moisture. The apparatus is accordingly adapted for hydroponic growing of plants, though it may also be used for aeroponic growing or for growing in soil or other media, including soil-like or sponge-like media or various synthetic rooting media.

The disk 12 has a center bore 32 at its axis of rotation. A lamp 34 extends through the bore and is connected to a support member and power source (not shown in the drawings). It is preferable that the lamp not illuminate the roots at the back side of the disk.

The plant-growing apparatus 10 is operated according to the following method. Seedlings are placed in the receptacles 26 with their roots in the root holders 28 and their shoots extending from the front side 19 of the disk. The motor 24 is actuated to rotate the disk at a selected speed, for example one revolution per hour. The lamp 34 is turned on and water and/or nutrients are delivered as needed onto the root holders 28. The seedlings grow into plants of a size suitable for harvesting after a selected period of time, for example one week. By virtue of the constant rotation of the disk, the tendency of the plant stems to grow upward as a result of geotropism is overcome and the plant stems grow in a direction that is approximately parallel to the axis of rotation of the disk. The plants are harvested when they reach the desired size, or when particular parts of the plants, such as fruits or leaves, are ready to be harvested.

The plant-growing apparatus 10 can readily be adapted for growing plants in a direction other than horizontal. To do this, the support table 36 is placed on a tilting mechanism which can tilt the table, and with it the plant-growing apparatus 10, so that the axis of rotation of the disk is at any desired angle from the vertical. For example, the axis of rotation can be tilted to a 45 degree angle.

The disk 12 can be solid as illustrated, made of plastic, metal, etc., or it can be a skeletal framework, with, for example, a circumferential rim supported by spokes which hold the root holders.

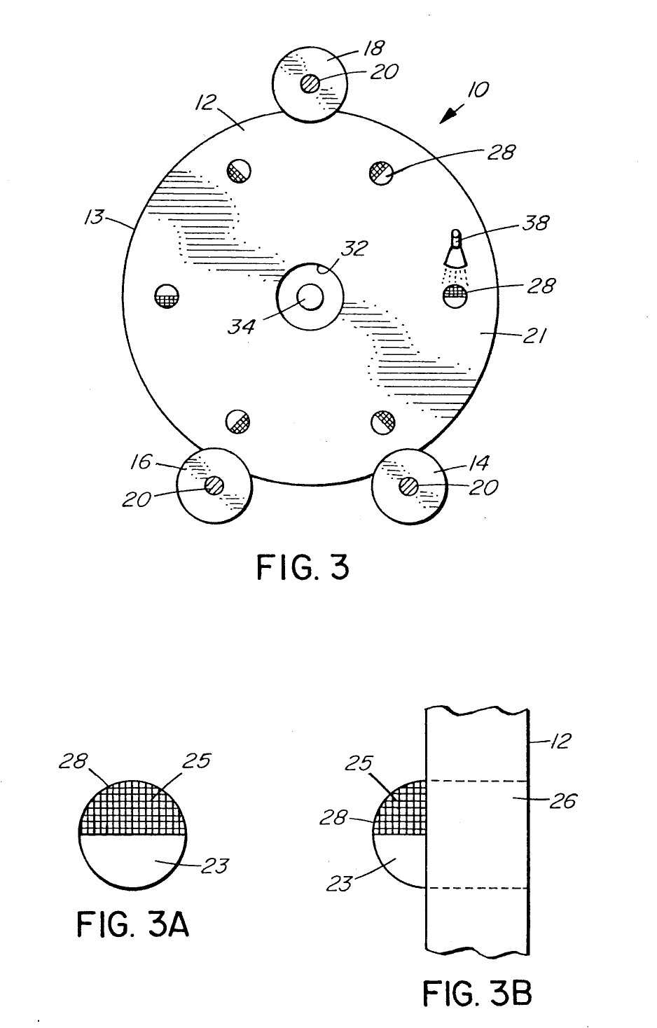

Optionally, as shown in FIG. 3C, the disk 12 can include a cover 41 on the back side 21 thereof, spaced from the back side 21 and attaching to it near the circumferential rim 13. The cover helps to contain moisture about the plant roots and stop water and nutrients from spraying or dripping away from the apparatus. The cover also facilitates the growing of root crops, as the space between the cover and the back side of the disk provides a suitable place for root crops, such as potatoes, to grow. A water sprayer 38 extends through the axial opening 33 in the cover and has a sprayhead 35 at its end in the space between the cover 41 and the back side 21 of the disk 12 for watering the plant roots. Drainage openings 45 are provided in the periphery of the cover so water can drain out when a drainage opening is at or near the bottom position of a rotation. Drainage opening covers 47 partially cover the openings 45 to limit the dripping of water as an opening 45 is rotated upward, for example as an opening is rotated counterclockwise to about the four o'clock position in the view of FIG. 3C.

In an alternative embodiment of the plant-growing apparatus 10, no axial lamp 34 is used, and light is provided to the plants by sunlight, for example where the apparatus is operated in a greenhouse, or by lamps positioned other than axially, for example above the apparatus. In this embodiment, no center bore 32 at the axis of rotation is necessary.

In another alternative embodiment of the plant-growing apparatus 10, no motor and gearbox are provided to turn the support wheel 14, and the disk 12 is turned by means of the watering of the root holders 28. In this embodiment, the root holders are configured as shown in FIGS. 3A and 3B, with a water-impermeable portion 23 and a mesh portion 25 that is water-permeable. Water is sprayed onto the mesh portion 25 of a root holder when the root holder is in the position where the water-impermeable portion 23 is underneath the mesh portion, for example in the three o'clock position of FIG. 3. The weight of the water in the root holder causes the disk to rotate (clockwise in the orientation of FIG. 3). Successive root holders are watered in the same manner as the disk rotates and they release most of their water as they rotate to the bottom position of the disk, allowing water to flow out of the mesh portions. The disk is therefore rotated in the manner of a waterwheel.

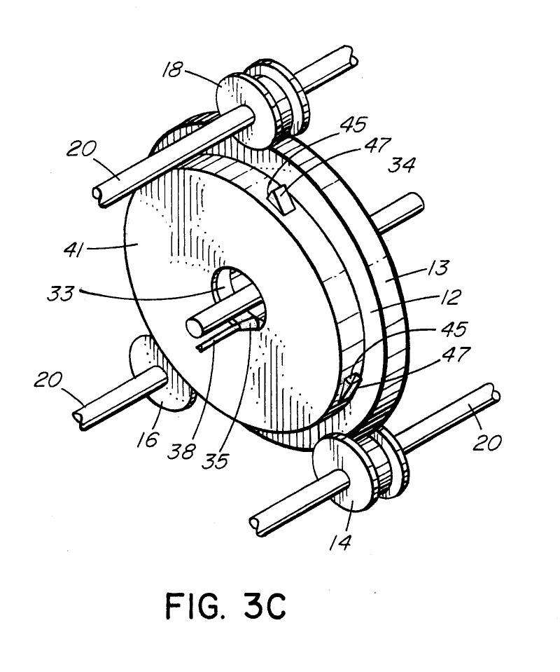

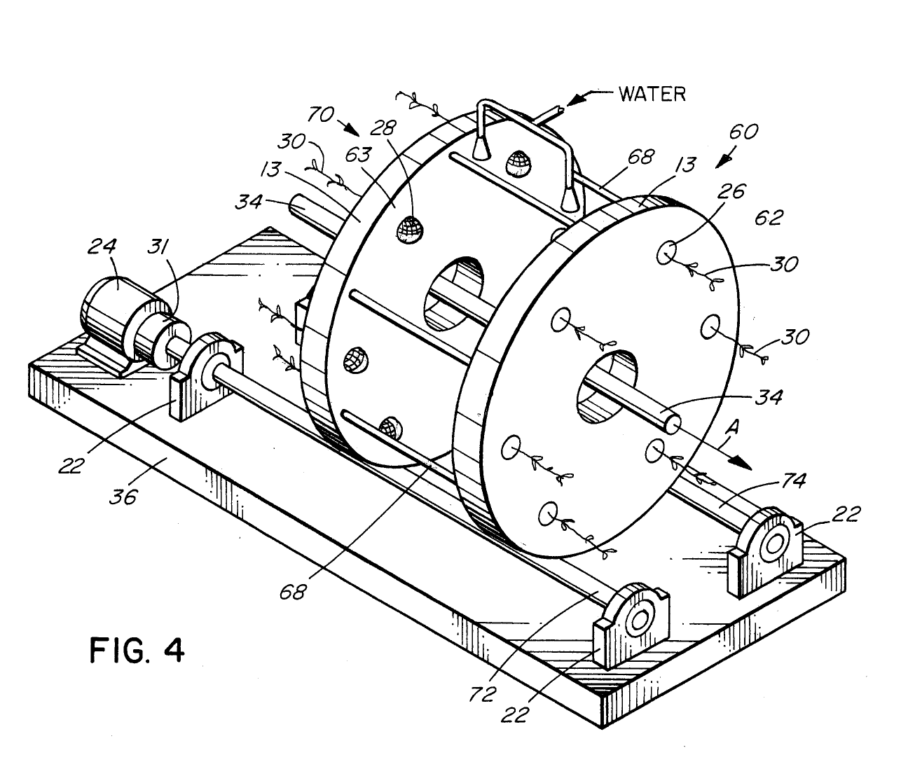

Referring next to the embodiment illustrated in FIGS. 4 and 5, the plant-growing apparatus 60 has a rotatable plant-holding member in the form of a cylindrical structure 70 which is held for rotation about its axis of rotation, indicated by arrow A, by two support rollers 72, 74. The axis of rotation is approximately horizontal.

The support rollers 72, 74 are rotatable on support bearings 22, which support the rollers on a table 36 or other support surface. One roller 72 is connected by a gearbox 31 to an electric motor 24, for rotating the roller and accordingly the cylindrical structure 70.

The cylindrical structure has two disks 62, 63 which form the ends of the cylinder, connected by disk-connecting rods 68 proximate to the circumferential rims 13 of the disks. The rims 13 engage the support rollers 72, 74. Each disk has an outward side 64 and an inward side 66. Each disk has a plurality of receptacles 26 in which plants 30 can grow. A root holder 28 is affixed behind each receptacle 26 at the inward side 66 of the disk to hold the roots of the plant 30 that grow through the receptacle. The root holder is porous, at least in part, to permit the watering of plant roots by the application of water from a water sprayer 38 onto the root holders 28. The root holder houses a conventional hydroponic medium.

The disks 62, 63 have a center bore 32 at the axis of rotation of the cylindrical structure 70. A lamp 34 extends through the bores and is connected to a support member and power source (not shown in the drawings).

Optionally, each disk 62, 63 can be provided with a cover (not shown in the drawings) on its respective inward side 66, similar to the cover 41 on the disk form of the apparatus as shown in FIG. 3C, and serving the same function as the cover 41.

The disks 62, 63 can be solid as illustrated, or they can comprise a skeletal framework with a circumferential rim.

The plant-growing apparatus 60 is operated according to the following method. Seedlings are placed in the receptacles 26 with their roots in the root holders 28 and their shoots extending from the outward sides 64 of the disks. The motor 24 is actuated to rotate the cylindrical structure 70 at a selected speed, for example one revolution per hour. The lamp 34 is turned on and water is delivered as needed onto the root holders 28. The seedlings grow into plants suitable for harvesting after a selected period of time, for example one week, and are then harvested by removing them from the cylindrical structure.

As described above with respect to the plant-growing apparatus 10 of FIGS. 1 to 3, the support table 36 for the plant-growing apparatus 60 can be placed on a tilting mechanism to tilt the apparatus so that the axis of rotation is at a different angle. In such case, circumferential flanges on the support rollers are required to retain the rims 13 of the disks 62, 63 in position on the support rollers.

Alternatively, the plant-growing apparatus 60 can exclude the axial lamp 34 and the plants can be illuminated by sunlight or other means, as discussed above with respect to the apparatus of FIGS. 1 to 3.

Alternatively, the plant-growing apparatus 60 can also exclude the motor and gearbox and be rotated by the watering process, as described above with respect to the apparatus of FIGS. 1 to 3.

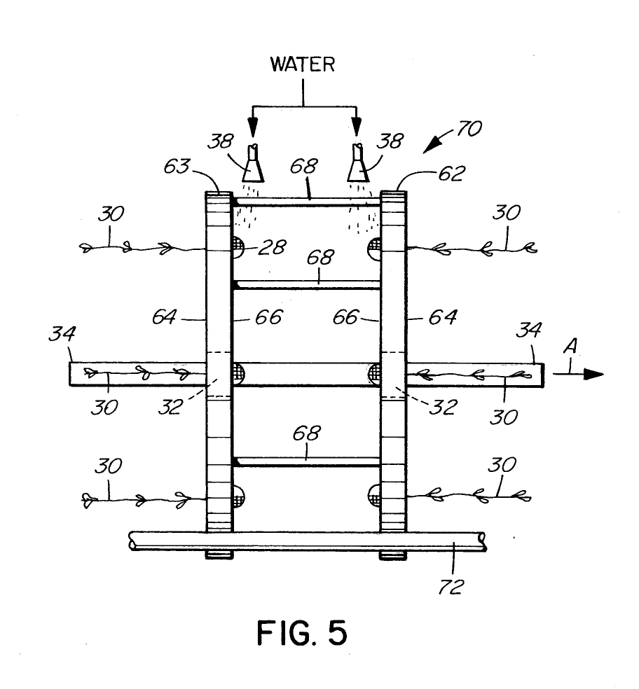

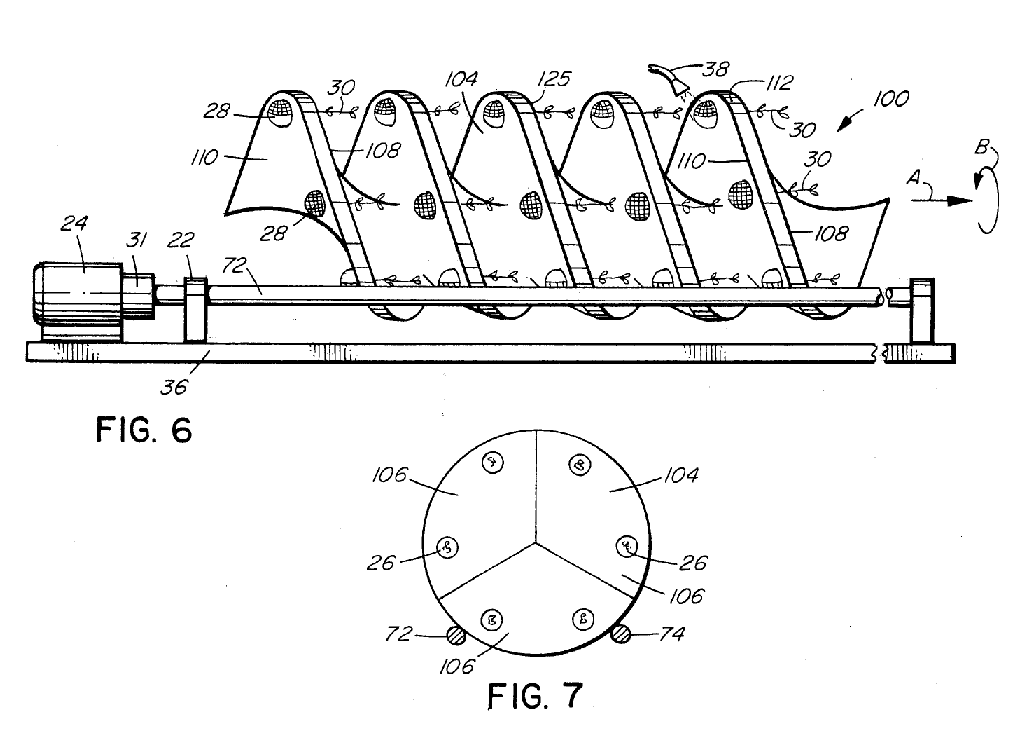

Referring next to the embodiment of FIGS. 6 and 7, the plant-growing apparatus 100 has a rotatable plant-holding member in the form of a helical blade 104, which is supported for rotation about its axis of rotation, indicated by arrow A, by two support rollers 72, 74. The axis of rotation is approximately horizontal.

The support rollers 72, 74 are rotatable on support bearings 22, which support the rollers on a table 36 or other support surface. One roller 72 is connected by a gearbox 31 to an electric motor 24, for rotating the roller and accordingly the helical blade.

The helical blade 104 comprises a plurality of detachable segments 106, three segments per revolution of the helix in the illustrated embodiment. These segments can be easily detached and re-attached by a snap fitting or other means of attachment. The helical blade 104 has a rim 112 at the outer edge of the blade which engages the support rollers 72, 74. The blade has a forward side 108 and a rearward side 110. The blade has a plurality of receptacles 26 in which plants 30 are grown. The helical blade is configured so there is sufficient distance between successive flights 125 of the blade to provide space for plants to grow to a desired size. A root holder 28 is affixed behind each receptacle 26 at the rearward side 110 of the blade to hold the roots of the plant 30 which grows through the receptacle. The root holder is water-permeable, at least in part, to permit the watering of plant roots by the application of water from a water sprayer 38 onto the root holders 28. The root holder houses a conventional hydroponic medium.

Optionally, the helical blade 104 can be provided with a cover (not shown in the drawings) on the rearward side 110 thereof, similar to the cover 41 on the disk form of the apparatus as shown in FIG. 3C and described above, and serving the same function as the cover 41.

The plant-growing apparatus 100 is operated according to the following method. Seedlings are placed in the receptacles 26 with their roots in the root holders 28 and their stems extending from the forward side 108 of the helical blade 104. The motor 24 is actuated to rotate the helical blade at a selected speed, for example one revolution per hour. The seedlings are exposed to light, either sunlight or artificial light, for example from lamps placed above the apparatus. The seedlings grow into plants suitable for harvesting after a selected period of time, for example one week. The tendency of the plants to grow upward as a result of geotropism is overcome and the plant stems grown in a direction that is approximately parallel to the axis of rotation.

As the helical blade rotates in the direction indicated by arrow B in FIG. 6, it moves along the support rollers 72, 74 in the direction indicated by arrow A. The helical blade will accordingly be in a different location when the plants are ready for harvesting than it was when the seedlings were planted. For example, it may have moved on the support rollers from one end of a greenhouse to the other end. At the harvest location, the plants are removed from the helical blade. Optionally, the segments 106 at the forward end of the blade are removed, one by one, and the plants are harvested from them. The detaching of segments permits the plant-growing apparatus 100 to be operated on a continuous basis. For example, with a helical blade that extends from a planting location to a harvesting location, segments 106 with grown plants are removed, serially, at the harvesting location, and segments with seedlings to be grown are attached to the blade, serially, at the planting location.

The helical blade can also be moved along the support rollers in the opposite direction, by reversing the direction of rotation of the electric motor 24. The helical blade can therefore be moved back and forth along the support rollers 72, 74. This could be done, for example, to increase the growing time for the plants before they are harvested.

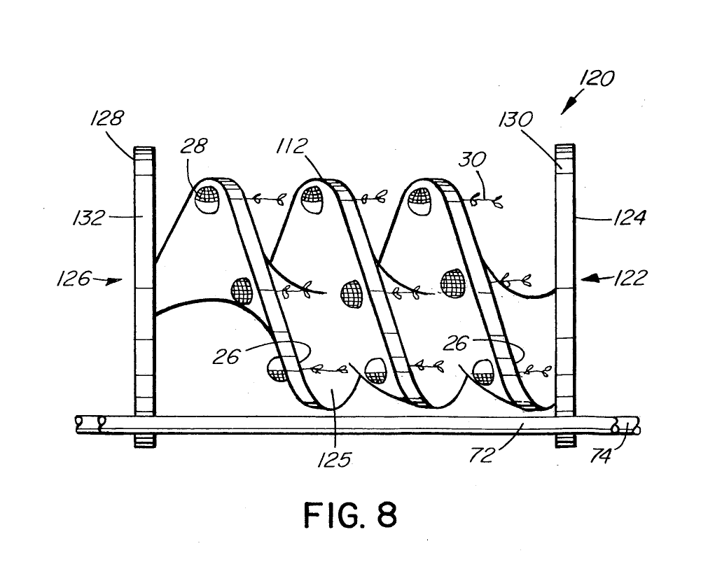

FIG. 8 illustrates an alternative embodiment of the helical blade form of the plant-holding member, in which the blade rotates in a fixed position rather than advancing along the support rollers as it rotates. The plant-holding member 120 has at its forward end 122 a support wheel or disk 124 having a diameter that is larger than the diameter of the flights 125 of the helical blade. Likewise, a disk 128 is provided at the rearward end 126 of the blade and has a diameter the same as that of the forward disk 124. The circumferential rims 130, 132 of the disks 124, 128 respectively, engage the support rollers 72, 74, while the outer rims 112 of the helical blade are spaced from and do not engage the support rollers 72, 74. The plant-holding member 120 accordingly remains in one position on the rollers as it is rotated, rather than advancing along the rollers.

The disks 124, 128 can be formed as an integral part of the helical blade or they can be separate parts which are rigidly affixed to the ends of the helical blade.

Although the invention has been described in terms of various embodiments, it is not intended that the invention be limited to these embodiments. Various modifications within the scope of the invention will be apparent to those skilled in the art.

For example, the root holders of the plant-holding members can take various forms. The root holder can comprise a set of prongs or other framework on which the roots can be supported. The root holder can have a structure which is fully open about the roots and does not enclose them, either partially or fully. The roots can also simply hang in space without any support, with the plant being held in place by attaching the stem to the plant-holding member, in which case no root holder is required.

Instead of configuring the root holders to permit the plant-holding members to be rotated by means of directing water on the root holders, as described above, a separate set of water receptacles or cups can be provided on the plant-holding member for this purpose. This permits the root holders to be omitted, or to be configured in a form that will not hold water, while still providing for rotation of the plant-holding member by the application of water.

The disk 12 of the apparatus 10 and the disks 62, 63 of the apparatus 60 can be round as illustrated or be other shapes, such as elliptical, that permit rotation on their circumferential rims.

For the helical member forms of plant-holding member, the plant-holding member can include an axial shaft on which the helical blade is affixed, or it can have no axial shaft, or it can have a free inner edge, being open at its axis of rotation. The member can be a solid blade as illustrated, or it can comprise a skeletal framework.

All such modifications are within the scope of the invention, which is defined by the claims that follow.

1. An apparatus for growing plants, comprising:
(a) a rotatable plant-holding member having an axis of rotation that is at an angle from vertical and having a circumferential rim;
(b) means on the plant-holding member for holding plants for growth in a direction that is approximately parallel to the axis of rotation of the plant-holding member;
(c) support means for supporting the plant-holding member at a non-axial position thereon for rotation about its axis of rotation; and
(d) means for rotating the plant-holding member.

2. An apparatus according to claim 1, wherein the non-axial position at which the support means supports the plant-holding member is at the circumferential rim of the plant-holding member.

3. An apparatus according to claim 1, wherein the plant-holding member comprises a cylindrical structure having two outwardly-facing sides and two inwardly-facing sides.

4. An apparatus according to claim 3, wherein the means for holding plants comprises plant-root holders.

5. An apparatus according to claim 4, wherein the plant-root holders are positioned at the inwardly-facing sides of the cylindrical structure, such that roots of the plants grow inwardly of the cylindrical structure and shoots of the plants grow outwardly of the cylindrical structure.

6. (canceled)

7. An apparatus according to claim 1, wherein the support means comprises rotatable support wheels which engage the circumferential rim of the plant-holding member.

8-12. (canceled)

13. An apparatus according to claim 1, wherein the angle is approximately 90 degrees.

14. (canceled)

15. An apparatus according to claim 1, further comprising a lamp positioned at the axis of rotation of the plant-holding member.

16-19. (canceled)

20. An apparatus according to claim 1, further comprising tilting means for varying the angle of the axis of rotation of the plant-holding member.

21. An apparatus for growing plants, comprising:
(a) a rotatable plant-holding member having an axis of rotation that is at an angle from vertical, the plant-holding member comprising a helical member having a forward side and a rearward side;
(b) means on the plant-holding member for holding plants;
(c) support means for supporting the plant-holding member for rotation about its axis of rotation; and
(d) means for rotating the plant-holding member.

22. An apparatus according to claim 21, wherein the helical member is a blade.

23. An apparatus according to claim 21, wherein the support means comprises rotatable support rollers.

24. An apparatus according to claim 21, wherein the means for holding plants comprises plant-root holders.

25. An apparatus according to claim 21, wherein the root holders are positioned at the rearward side of the helical member, such that roots of the plants grow from the rearward side of the helical member and shoots of the plants grow from the forward side of the helical member.

26. An apparatus according to claim 21, wherein the angle is approximately 90 degrees.

27. An apparatus according to claim 23, wherein the means for rotating the plant-holding member comprises a motor for driving one or more of the support rollers.

28. An apparatus according to claim 21, wherein the means for rotating the plant-holding member comprises a water-feeding means for delivering water to the plants.

29. An apparatus according to claim 21, further comprising tilting means for varying the angle of the axis of rotation of the plant-holding member.

30. An apparatus according to claim 21, wherein the helical member comprises a plurality of detachable segments.

31. An apparatus according to claim 21, wherein the plant-holding member further comprises at least two spaced-apart support wheels having a diameter larger than the diameter of the flights of the helical member, the support wheels having respective circumferential rims which engage the support means.

32-36. (canceled)
